(19) United States
(12) Patent Application Publication
(10) Pub. No.: US 2010/0306325 A1
(43) Pub. Date: Dec. 2, 2010

(54) Animated Wedding Collection System and Method

(76) Inventors: Alison Cobb Poole, Oviedo, FL (US); James Cabell Poole, Oviedo, FL (US)

Correspondence Address: Matthew G. McKinney;Shuffield, Lowman & Wilson, P.A., 1000 Legion Place, Suite 1700, Orlando, FL, 32801, US

(21) Appl. No.: 12/476,715

(22) Filed: Jun. 2, 2009

(51) Int. Cl. G06F 15/16; G06Q 10/00; G06Q 50/00

(52) U.S. Cl. 709/206; 705/8; 345/473

(57) ABSTRACT

An animated wedding collection system and method is disclosed. In a particular embodiment, the method includes receiving a request from a user to create a wedding collection for a wedding, authenticating the user, and prompting the user to enter wedding information for the wedding. The method further includes generating an electronic wedding message, where the electronic wedding message includes digital animation, and transmitting the electronic wedding message to an invitee. In addition, the method includes selectively sending a paper wedding message to the invitee, where the paper wedding message is similar in appearance to the electronic wedding message, generating an electronic save the date card, transmitting the save the date card to the invitee, generating an electronic place card, and transmitting the electronic place card. The method further includes generating an electronic thank you card, and transmitting the electronic thank you card to an invitee of the wedding.

### FIELD

The present invention relates in general to the field of wedding planning, and in particular to an animated wedding collection system and method.

### DESCRIPTION OF RELATED ART

A wedding collection typically includes wedding invitations, save the date cards, place cards and thank-you cards. Electronic wedding invitations are becoming more prevalent as a low cost alternative to sending paper wedding invitations. In addition, the Internet is providing opportunities to couples to incorporate an email wedding registry, wedding event hosting, budget planning, wedding website creation and overall management of wedding events. Internet electronic wedding planners may include different functions to be performed through the electronic medium such as making a list of guests, inviting them via electronic email invitations, looking after seating arrangements, and receiving RSVPs from the invitations.

However, the Internet wedding planner used to manage the wedding or to send electronic wedding invitations is not tailored to provide a unique experience. For example, an electronic wedding invitation is typically a web page with multiple sections and does not create the same experience as holding the invitation in the recipient's hands and is not interactive. Another shortcoming of the prior art is that the electronic wedding invitation is not customized or personalized to the bride and groom and for each recipient. The RSVP is posted for all other invited guests to see and does not maintain the privacy of the guest. Further, there is no option for the recipient to save the electronic wedding invitation to local storage media or to receive a paper copy of the wedding invitation that is similar in appearance to the electronic wedding invitation. Accordingly, there is a need in the relevant art for an animated wedding collection system and method that is interactive and personalized to the bride and groom and for each guest, and that creates a unique experience.

However, in view of the prior art at the time the present invention was made, it was not obvious to those of ordinary skill in the pertinent art how the identified needs could be fulfilled.

### SUMMARY

In a particular embodiment, an animated wedding collection method is disclosed. The method includes receiving a request from a user to create a wedding collection for a wedding, authenticating the user, and prompting the user to enter wedding information for the wedding. The method further includes generating an electronic wedding message, where the electronic wedding message includes digital animation, and transmitting the electronic wedding message to an invitee.

In addition, the method includes selectively sending a paper wedding message to the invitee, where the paper wedding message is similar in appearance to the electronic wedding message, generating an electronic save the date card, transmitting the save the date card to the invitee, generating an electronic place card, and transmitting the electronic place card, where the electronic place card indicates where the invitee will be sitting at the wedding. The method further includes generating an electronic thank you card, and transmitting the electronic thank you card to an invitee of the wedding, where the electronic thank you card includes a name of the invitee.

In another particular embodiment, an animated wedding collection method is disclosed. The method includes receiving an electronic wedding message, displaying an envelope image on a monitor, displaying animation of moving images of a wedding invitation image being removed from within the envelope image on the monitor, and displaying selected data on the wedding invitation image on the monitor to the invitee. The method further includes that the envelope image includes a name of the invitee and the electronic wedding message further comprising a response request (“RSVP”) for the invitee to return electronically to the user indicating a response to the wedding invitation. In addition, the method includes that the electronic wedding message is configured to be stored on computer readable storage medium of the invitee.

In another particular embodiment, an animated wedding collection system is disclosed including computer readable storage medium containing processor executable instructions, which, when executed by a processor, cause the processor to receive a request to create a wedding collection for a wedding, authenticate a user, prompt the user to enter wedding information for the wedding, generate an electronic wedding message, and transmit the electronic wedding message to an invitee. The processor instructions are also executable to cause a processor to generate an electronic save the date card, transmit the save the date card to the invitee, generate an electronic place card, transmit the electronic place card, where the electronic place card indicates where the invitee will be sitting at the wedding. The electronic wedding message may further include a response request (“RSVP”) for the invitee to return electronically to the user indicating a response to the wedding invitation. In addition, the processor instructions are also executable to cause the processor to generate an electronic thank you card, transmit the electronic thank you card to an invitee of the wedding, where the electronic thank you card includes a name of the invitee. The system may also include sending a paper wedding message to the invitee, where the paper wedding message is similar in appearance to the electronic wedding message.

In yet another particular embodiment, an animated wedding collection system is disclosed including computer readable storage medium containing processor executable instructions, which, when executed by an invitee processor, cause the invitee processor to display an envelope image, display animation of moving images of a wedding invitation image being removed from within the envelope image, and display selected data on the wedding invitation image to the invitee. The envelope image includes a name of the invitee. The wedding message is configured to be stored on a computer readable medium.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a flow diagram of a particular illustrative embodiment of an animated wedding collection method;

FIG. 2 is a general diagram of a graphical user interface that can be used to enter wedding information for a wedding into a database;

FIG. 3 is an illustrative diagram of a paper wedding invitation in accordance with a particular illustrative embodiment of the animated wedding collection method;

FIG. 4 is a general diagram of a graphical user interface that can be used to enter invitee information into the database;

FIG. 5 is an illustrative diagram of a paper envelope addressed to an invitee in accordance with a particular illustrative embodiment of the animated wedding collection method;

FIG. 6 is a screen shot of an envelope image addressed to the invitee in accordance with a particular illustrative embodiment of the animated wedding collection method;

FIG. 7 is a screen shot of moving images of a wedding invitation image being removed from within the envelope image in accordance with a particular illustrative embodiment of the animated wedding collection method;

FIG. 8 is a flow diagram of a particular illustrative embodiment of an animated wedding collection method;

FIG. 9 is a flow diagram of a particular illustrative embodiment of an animated wedding collection method;

FIG. 10 is a block diagram of a particular illustrative embodiment of an animated wedding collection system; and

FIG. 11 is a block diagram of an illustrative embodiment of a general computer system.

### DETAILED DESCRIPTION

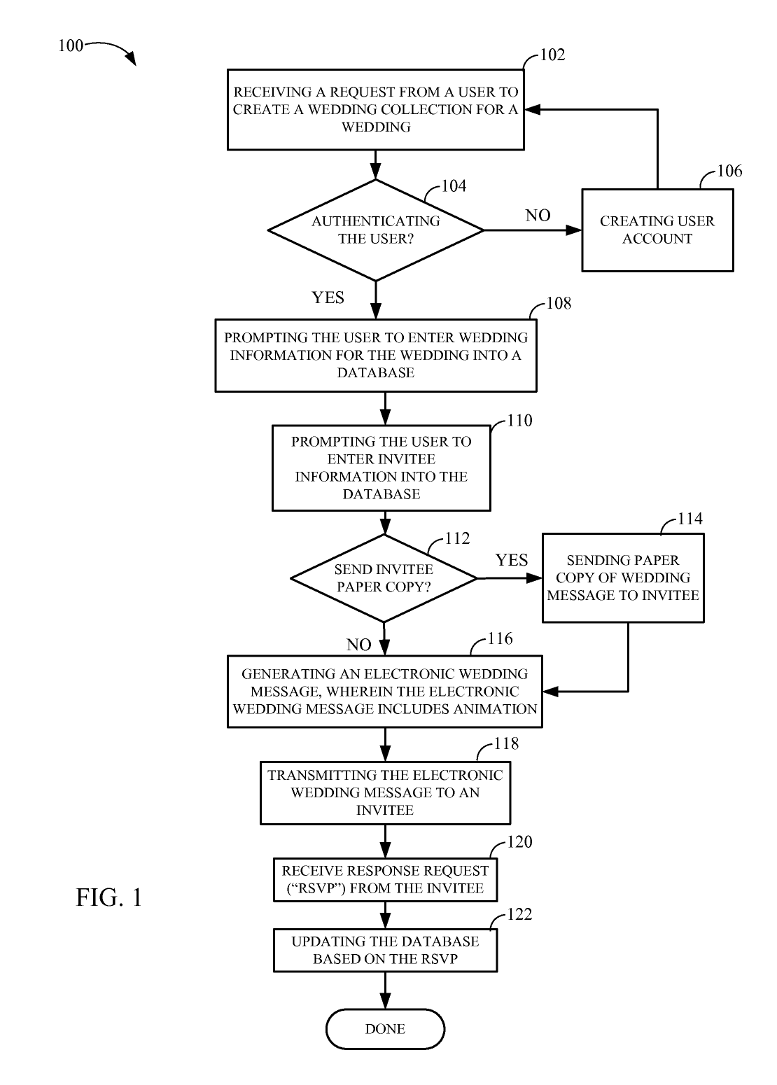

Referring to FIG. 1, a particular illustrative embodiment of an animated wedding collection method is disclosed and generally designated 100. The method includes receiving a request from a user to create a wedding collection for a wedding at 102. The user is authenticated at 104. If the user cannot be authenticated, then a user account is created at 106. After the user is authenticated, at 104, the user is then prompted to enter wedding information for the wedding into a database at 108. Continuing to 110, the user is prompted to enter invitee information into the database. At 112, the user may select to send an invitee a paper copy of the wedding message. Moving to 116, an electronic wedding message is generated, where the electronic wedding message includes animation. The electronic wedding message is transmitted, at 118, to an invitee. A response request (“RSVP”) may be subsequently received from the invitee, at 120. The database is updated, at 122, based on the RSVP.

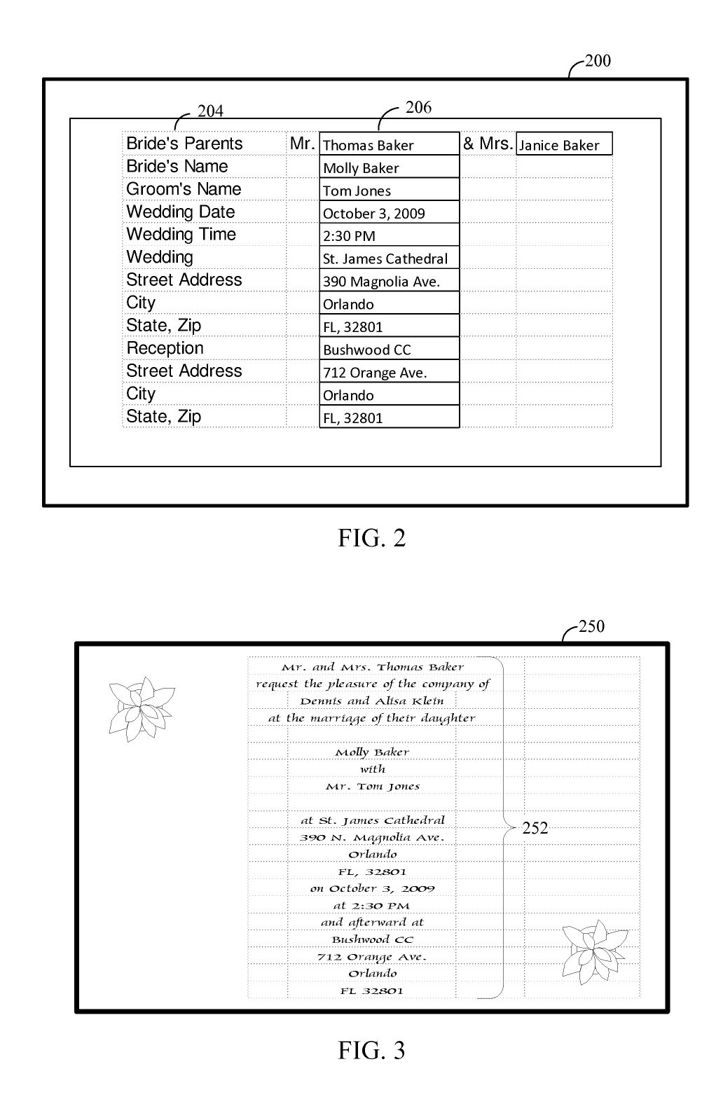

A graphical user interface (“GUI”) 200 shown in FIG. 2 may be used by a user to enter wedding information 204 in accordance with the method of FIG. 1. For example, the wedding information 204 may include the name of the bride's parents, the bride's name, groom's name, wedding date, wedding time, the wedding place including street address, city, state and zip code, reception address including street address, city, state, and zip code. The wedding information 204 is entered in the appropriate entry blanks 206 of the GUI 200 as shown in FIG. 2 and saved to a database. Using the saved wedding information 206, a paper wedding invitation 250 may be generated displaying the wedding information in a selected format 252 and the paper wedding invitation 204 may be sent to a designated invitee.

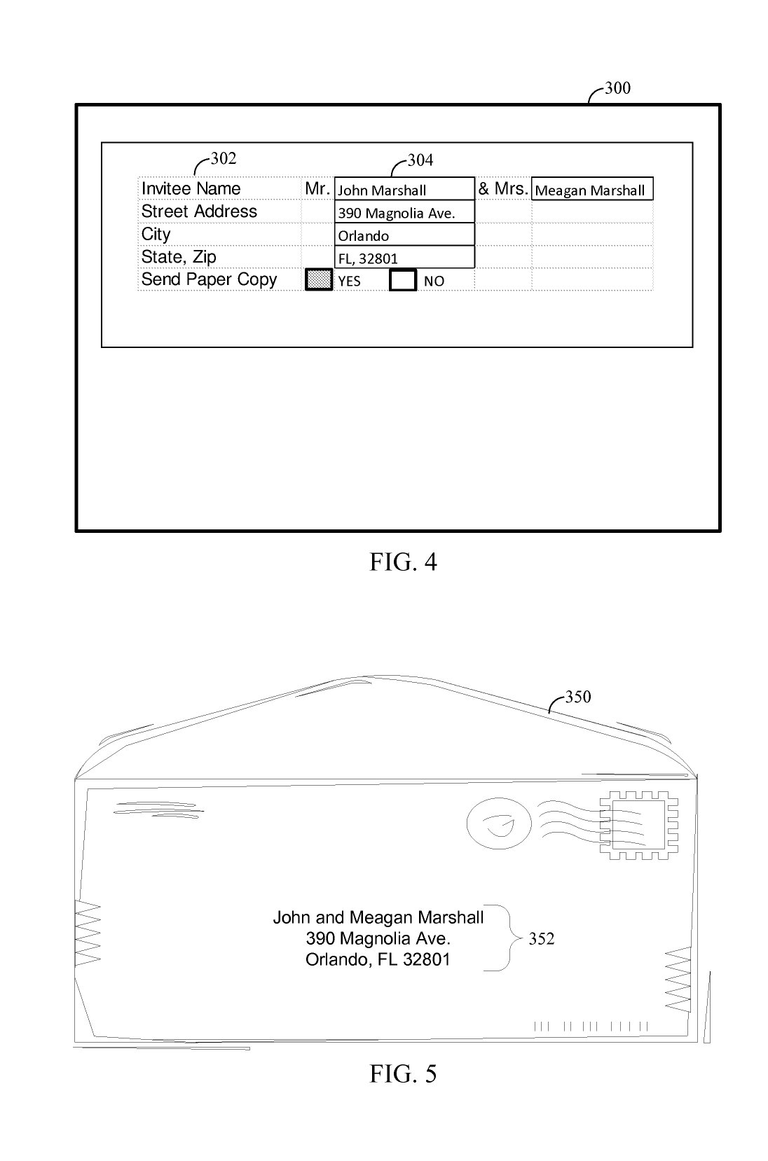

A GUI 300 shown in FIG. 4 may be used by the user to enter invitee information 302 in accordance with the method of FIG. 1. The invitee information may include, for example, the name of the invitee, street address, city, state, and zip code. The invitee information 302 is entered in the appropriate blanks 304 of the GUI 300 as shown in FIG. 4 and saved to the database. An electronic wedding message is generated, where the electronic message includes digital animation. The electronic message is sent to an invitee. In addition, the user may select whether a paper copy of a wedding message should be sent to the invitee using GUI 300. Referring now to FIG. 5, the invitee information 304 is printed on a paper envelope 350 so that it may be delivered to the designated invitee 352 if the user selects to have a paper copy of the wedding message sent to the invitee. The paper envelope 350 in FIG. 5 is shown with envelope flap in the open position.

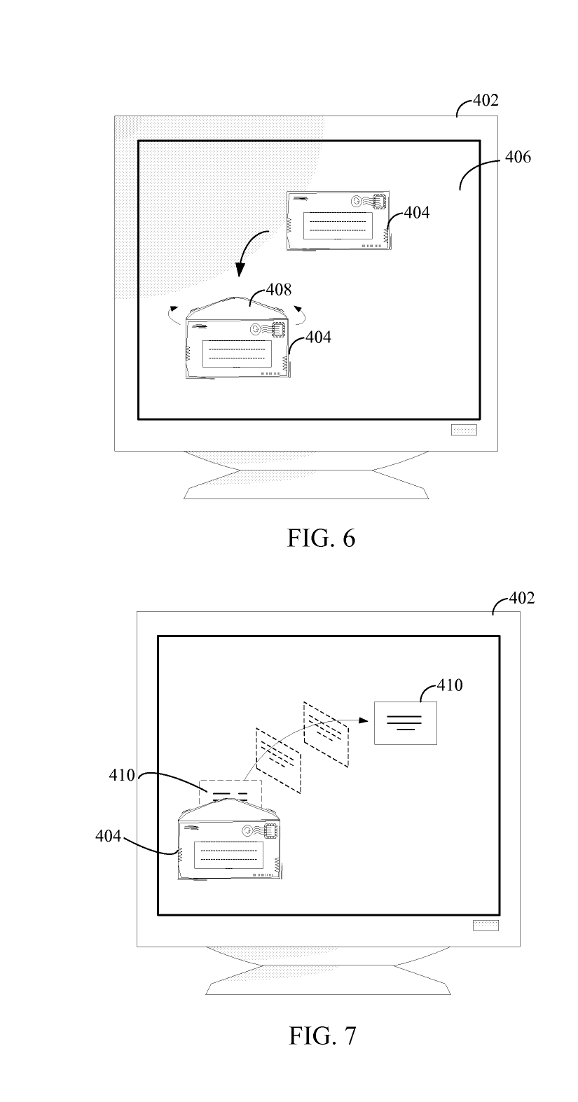

The invitee receives the electronic wedding message. As shown in FIG. 6, an envelope image 404 is displayed that is similar in appearance to the paper envelope 350 shown in FIG. 5 except that the envelope image is shown in the closed position. Digital animation includes showing the envelope image to open a flap 408 similar to opening the paper envelope 350. The envelope image 404 displays the invitee information 304 similar to the paper envelope 350 as addressed to the invitee. A computer monitor 402 may be used to display the envelope image 404. Referring now to FIG. 7, digital animation includes moving images of the wedding invitation image 410 as it is being removed from within the envelope image 404. Selected data 252 may be displayed on the wedding invitation image 410 to the invitee similar to receiving a paper copy of the envelope 350 and wedding invitation 250.

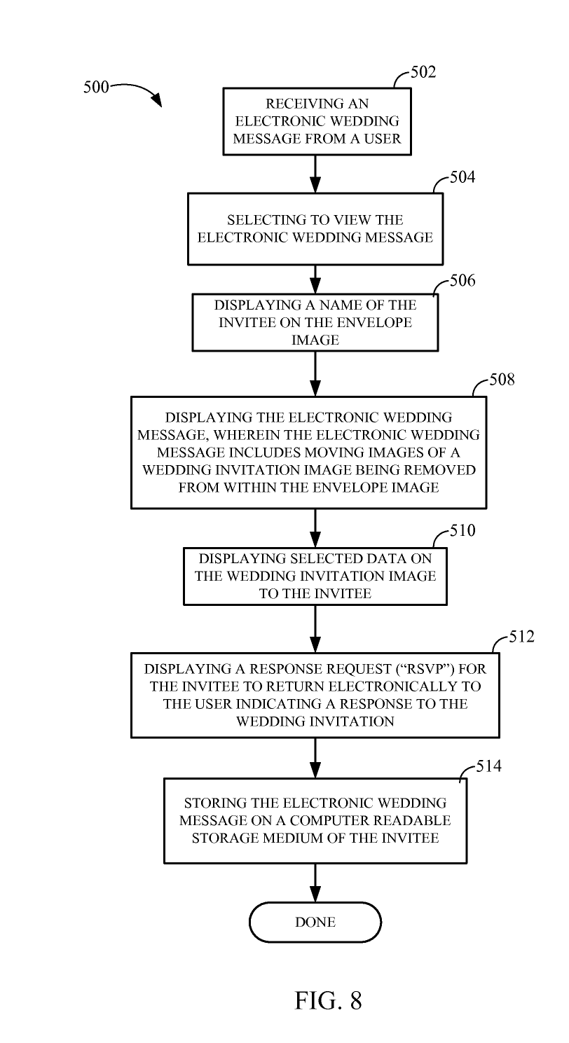

Referring to FIG. 8, a particular illustrative embodiment of an animated wedding collection method is disclosed and generally designated 500. The method includes receiving an electronic wedding message from a user at 502 through email, for example. At 504, the invitee selects to view the electronic wedding message. The name of the invitee is displayed on the envelope image at 506. The electronic wedding message is then displayed, at 508, where the electronic wedding message includes moving images of a wedding invitation being removed from within the envelope image. Continuing to 510, selected data is displayed on the wedding invitation image to the invitee. A response request (“RSVP”) is displayed to the invitee that may be returned electronically to the user indicating a response to the wedding invitation, at 512. In addition, at 514, the electronic wedding message may be stored on a computer readable storage medium of the invitee.

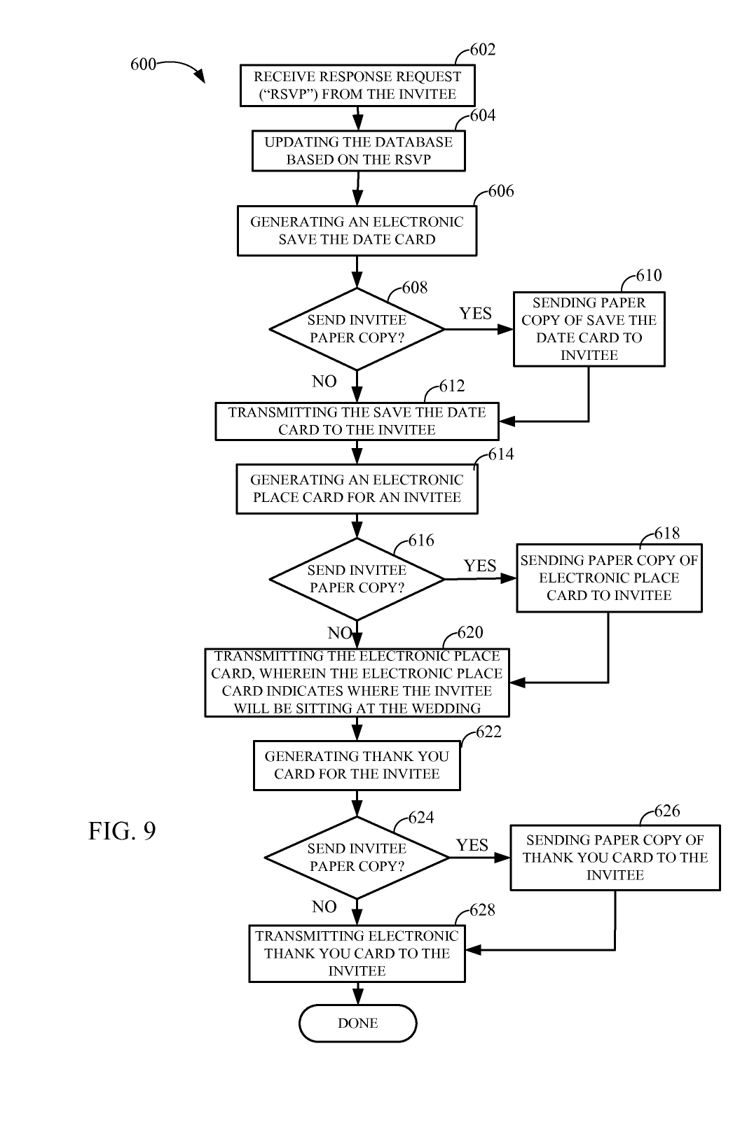

The RSVP is received from the invitee, at 602, as shown in FIG. 9. The database is updated based on the RSVP. An electronic save the date card is generated at 606. At 608, the user may select to send an invitee a paper copy 610 of the save the date card in addition to the electronic save the date card. The electronic save the date card is transmitted to the invitee at 612. Moving to 614, an electronic place card is generated and, at 616, the user may select to send an invitee a paper copy 618 of the place card to the invitee. The electronic place card is transmitted to the invitee, at 620, where the electronic place card indicates where the invitee will be sitting at the wedding. Subsequent to the wedding date, a thank you card is generated at 622. The user may select, at 624, to send the invitee a paper copy 626 of the thank you card. The thank you card is transmitted to the invitee, at 628.

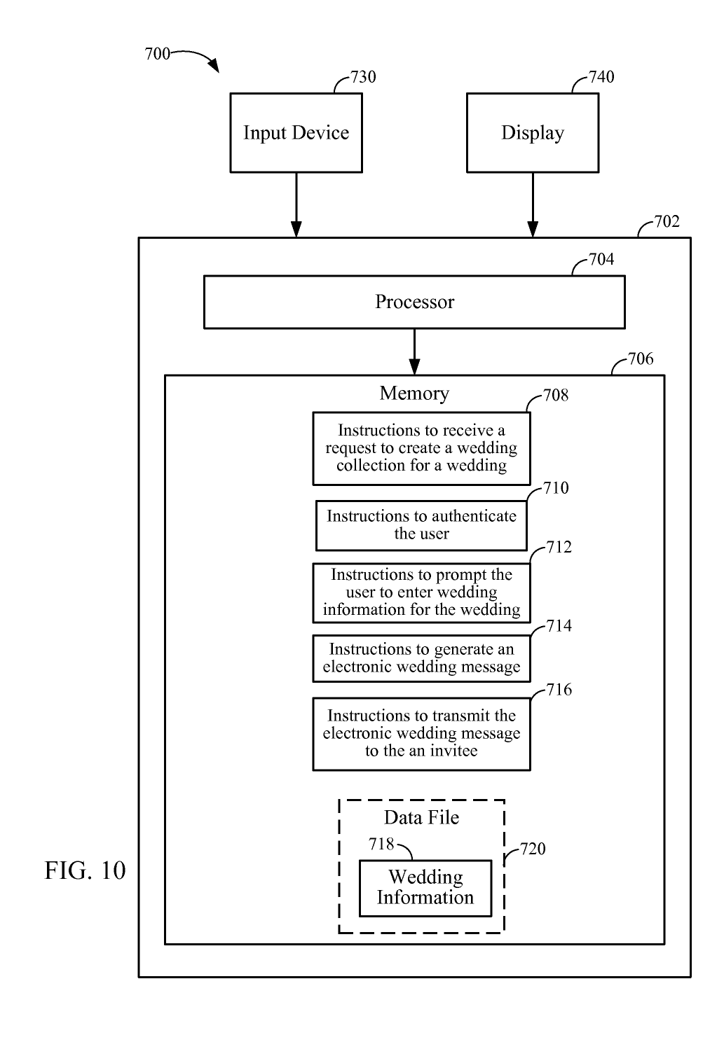

A block diagram of a particular embodiment of an animated wedding collection system is disclosed in FIG. 10 and generally designated 700. In a particular embodiment, the system 700 may be a physical tool configured to perform the methods depicted in FIGS. 1, 8 and 9. The system 700 includes a device 702 having at least one processor 704 and a memory 706 that is accessible to the processor 704. The memory 706 includes media that is readable by the processor 704 and that stores data and program instructions that are executable by the processor 704. For example, the processor 704 may receive instructions to receive a request to create a wedding collection for a wedding 708, instructions to authenticate the user 710, instructions to prompt the user to enter wedding information for the wedding 712, instructions to generate an electronic message 714, where the electronic wedding message includes animation, and instructions to transmit the electronic wedding message to the invitee 716. A data file 720 may store wedding information 718 and invitee information. An input device 730 and a display 740 are coupled to the device 702. In a particular embodiment, the input device 730 may include a keyboard, a pointing device, a touch screen, a speech interface, another device to receive user input, or any combination thereof. Although depicted as separate components, the instructions to receive a request to create a wedding collection for a wedding 708, instructions to authenticate the user 710, instructions to prompt the user to enter wedding information for the wedding 712, instructions to generate an electronic message 714, where the electronic wedding message includes animation, and instructions to transmit the electronic wedding message to the invitee 716, or any combination thereof, may be integrated into a single software package or software applications that are compatible to interoperate with each other.

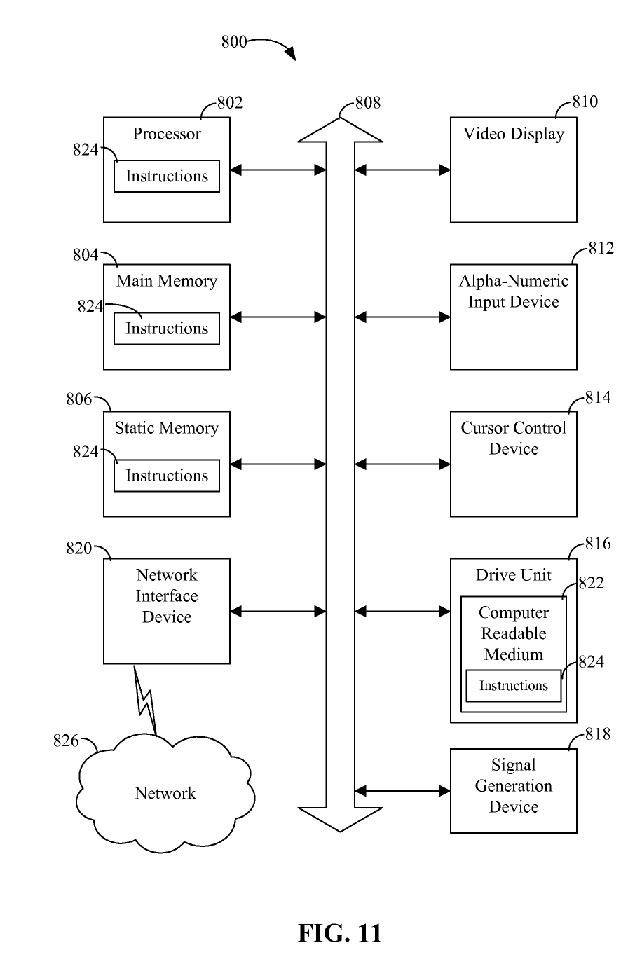

As illustrated in FIG. 11, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), a flat panel display, a solid-state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820 that may be in communication with a network 826 and telephony system.

In a particular embodiment, as depicted in FIG. 11, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media. For example, the instructions 824 may include instructions to cause a processor to receive a request from a user to create a wedding collection for a wedding, authenticate a user, create a user account, prompt a user to enter wedding information for the wedding into a database, prompt the user to enter invitee information into the database, receive selection to send an invitee a paper copy of the wedding message, generate an electronic wedding message, where the electronic wedding message includes animation, transmitted the electronic wedding message to an invitee, and to receive a response request (“RSVP”) from the invitee.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

What is claimed is:

1. An animated wedding collection method, the method comprising:
receiving a request from a user to create a wedding collection for a wedding;
authenticating the user;
prompting the user to enter wedding information for the wedding;
generating an electronic wedding message, wherein the electronic wedding message includes digital animation; and
transmitting the electronic wedding message to an invitee.

2. The method of claim 1, wherein the electronic wedding message is an invitation to the wedding.

3. The method of claim 2, further comprising sending a paper wedding message to the invitee, wherein the paper wedding message is similar in appearance to the electronic wedding message.

4. The method of claim 3, further comprising:
generating an electronic save the date card; and
transmitting the save the date card to the invitee.

5. The method of claim 4, further comprising:
generating an electronic place card; and
transmitting the electronic place card, wherein the electronic place card indicates where the invitee will be sitting at the wedding.

6. The method of claim 5, further comprising:
generating an electronic thank you card; and
transmitting the electronic thank you card to an invitee of the wedding, wherein the electronic thank you card includes a name of the invitee.

7. An animated wedding collection method, the method comprising:
receiving an electronic wedding message;
displaying an envelope image on a monitor;
displaying animation of moving images of a wedding invitation image being removed from within the envelope image on the monitor; and
displaying selected data on the wedding invitation image on the monitor to the invitee.

8. The method of claim 7, wherein the envelope image includes a name of the invitee.

9. The method of claim 8, wherein the electronic wedding message further comprising a response request (“RSVP”) for the invitee to return electronically to the user indicating a response to the wedding invitation.

10. The method of claim 9, wherein the electronic wedding message is configured to be stored on computer readable storage medium of the invitee.

11. A wedding collection system, the system comprising computer readable storage medium containing executable instructions, which, when executed by a processor, cause the processor to:
receive a request to create a wedding collection for a wedding;
authenticate the user;
prompt the user to enter wedding information for the wedding;
generate an electronic wedding message; and
transmit the electronic wedding message to an invitee.

12. The system of claim 11, wherein the electronic wedding message is an invitation to the wedding.

13. The system of claim 12, wherein the electronic wedding message further comprising a response request (“RSVP”) for the invitee to return electronically to the user indicating a response to the wedding invitation.

14. The system of claim 13, further comprising executable instructions, that when executed by the processor, cause the processor to:
generate an electronic save the date card; and
transmit the save the date card to the invitee.

15. The system of claim 14, further comprising executable instructions, that when executed by the processor, cause the processor to:
generate an electronic place card; and
transmit the electronic place card, wherein the electronic place card indicates where the invitee will be sitting at the wedding.

16. The system of claim 15, further comprising executable instructions, that when executed by the processor, cause the processor to:
generate an electronic thank you card; and
transmit the electronic thank you card to an invitee of the wedding, wherein the electronic thank you card includes a name of the invitee.

17. The system of claim 16, further comprising executable instructions, that when executed by an invitee processor, cause the invitee processor to:
display an envelope image;
display animation of moving images of a wedding invitation image being removed from within the envelope image; and
display selected data on the wedding invitation image to the invitee.

18. The system of claim 17, wherein the envelope image includes a name of the invitee.

19. The system of claim 18, wherein the wedding message is configured to be stored on a computer readable medium.

20. The system of claim 19, further comprising a paper wedding message to the invitee, wherein the paper wedding message is similar in appearance to the electronic wedding message.
